(19) United States
(12) Patent Application Publication
(10) Pub. No.: US 2021/0253887 A1
(43) Pub. Date: Aug. 19, 2021

(54) CONDUCTIVE INKS

(71) Applicant: Agfa-Gevaert NV, Mortsel (BE)

(72) Inventor: Dirk Bollen, Mortsel (BE)

(21) Appl. No.: 17/053,887

(22) PCT Filed: May 6, 2019
(86) PCT No.: PCT/EP2019/061517

§ 371 Date: Nov. 9, 2020

(30) Foreign Application Priority Data
May 8, 2018 (EP) 18171221.7

(51) Int. Cl. C09D 11/52; C09D 11/322; C09D 11/033; C09D 11/037; C09D 11/106; B41M 5/00

(52) U.S. Cl. CPC C09D 11/52; C09D 11/322; B41M 5/0023; C09D 11/037; C09D 11/106; C09D 11/033

(57) ABSTRACT

A conductive ink comprising metallic nanoparticles, a liquid carrier and an optional binder, characterized in that liquid carrier includes between 0.5 and 7.5 wt % of a solvent selected from water and a compound comprising at least two hydroxyl groups.

### FIELD OF THE INVENTION

The present invention relates to conductive inks, for example nanosilver conductive inks. The invention also relates to a method of preparing the conductive ink and to conductive layers or patterns formed from the conductive ink, preferably at moderate curing conditions.

### BACKGROUND OF THE INVENTION

The interest in metallic printing or coating fluids comprising metallic nanoparticles has increased during the last decades due to their unique properties when compared to the bulk properties of a given metal. For example, the melting point of metallic nanoparticles decreases with decreasing particle size making them of interest for printed electronics, electrochemical, optical, magnetic and biological applications.

The production of stable and concentrated metallic printing or coating fluids, which can be printed or coated at high speed is of great interest as it enables the preparation of electronic devices at low costs.

Metallic printing or coating fluids are typically conductive inks comprising metallic nanoparticles and a dispersion medium. Such conductive inks can be directly used as a printing or coating fluid. However, additional ingredients are often added to the conductive ink to optimize the properties of the resulting metallic printing or coating fluids.

The preparation of metallic nanoparticles may be carried out in water or organic solvents by the so-called polyol synthesis as disclosed in for example ‘Approaches to the synthesis and Characterization of Spherical and Anisotropic Silver Nanomaterials, Metallic Nanomaterials Vol. 1, Edited by Challa S. S. R. Kumar, Wiley-VCH Verlag GmbH&Co.KGaA Weinheim, by a derivative of the polyol synthesis methodology or by an in-situ reduction of metallic salts in the presence of various reducing agents. Such methods are disclosed in for example US2010143591, US2009142482, US20060264518, EP-A 2147733, EP-A 2139007, EP-A 803551, EP-A 2012952, EP-A 2030706, EP-A 1683592, EP-A 166617, EP-A 2119747, EP-A 2087490, EP-A 2010314, WO2008/151066, WO2006/076603, WO2009/152388, WO2009157393.

The conductive inks are typically applied on a substrate by a printing technique such as inkjet printing, screen printing, or flexographic printing.

Screen printing is considered a cost effective method wherein high viscosity conductive inks may be printed on various substrates.

Conductive inks that may be used in a screen printing method are disclosed in for example EP-A 2781562, EP-A 3099145, EP-A 3287499 EP-A 3099146 and WO2017/102574.

Screen printing of silver inks involves different steps:
flooding of the screen or mesh, wherein the silver ink Is spread across the screen or mesh;
printing, wherein the silver ink is pushed through the screen openings on the substrate, and
levelling of the printed silver ink on the substrate after the screen has left the substrate, leaving the ink on the substrate.

The resolution of screen printed silver patterns is often not sufficient. Typically, so-called line widening and smearing may be the result of the screen printing process, resulting in an overall decrease of the resolution of the printed patterns that may be realized.

### SUMMARY OF THE INVENTION

It is an object of the present invention to provide a conductive ink wherewith conductive patterns having an improved resolution can be obtained.

This object is realized by a conductive ink as defined in claim 1.

Further advantages and embodiments of the present invention will become apparent from the following description and the dependent claims.

### BRIEF DESCRIPTION OF THE DRAWINGS

FIG. 1 schematically shows how widening (W) and smearing (S) of printed silver lines, used to evaluate the resolution of the printed silver lines in the examples, were determined.

### DETAILED DESCRIPTION OF THE INVENTION

### Definitions

The terms polymeric support and foil, as used herein, mean a self-supporting polymer-based sheet, which may be associated with one or more adhesion layers, e.g. subbing layers. Supports and foils are usually manufactured through extrusion.

The term layer as used herein, is considered not to be self-supporting and is manufactured by coating or spraying it on a (polymeric) support or foil.

PET is an abbreviation for polyethylene terephthalate.

The term alkyl means all variants possible for each number of carbon atoms in the alkyl group i.e. methyl, ethyl, for three carbon atoms: n-propyl and isopropyl; for four carbon atoms: n-butyl, Isobutyl and tertiary-butyl; for five carbon atoms: n-pentyl, 1,1-dimethylpropyl, 2,2-dimethylpropyl and 2-methyl-butyl et.

Unless otherwise specified a substituted or unsubstituted alkyl group is preferably a C₁ to C₆-alkyl group.

Unless otherwise specified a substituted or unsubstituted alkenyl group is preferably a C₂ to C₆-alkenyl group.

Unless otherwise specified a substituted or unsubstituted alkynyl group is preferably a C₂ to C₆-alkynyl group.

Unless otherwise specified a substituted or unsubstituted aralkyl group is preferably a phenyl group or a naphthyl group including one, two, three or more C₁ to C₆-alkyl groups.

Unless otherwise specified a substituted or unsubstituted alkaryl group is preferably a C₁ to C₆-alkyl group including an aryl group, preferably a phenyl group or naphthyl group.

Unless otherwise specified a substituted or unsubstituted aryl group Is preferably a substituted or unsubstituted phenyl group or naphthyl group.

A cyclic group includes at least one ring structure and may be a monocyclic- or polycyclic group, meaning one or more rings fused together.

A heterocyclic group is a cyclic group that has atoms of at least two different elements as members of Its ring(s). The counterparts of heterocyclic groups are homocyclic groups, the ring structures of which are made of carbon only. Unless otherwise specified a substituted or unsubstituted heterocyclic group Is preferably a five- or six-membered ring substituted by one, two, three or four heteroatoms, preferably selected from oxygen atoms, nitrogen atoms, sulphur atoms, selenium atoms or combinations thereof.

An alicyclic group is a non-aromatic homocyclic group wherein the ring atoms consist of carbon atoms.

The term heteroaryl group means a monocyclic- or polycyclic aromatic ring comprising carbon atoms and one or more heteroatoms in the ring structure, preferably, 1 to 4 heteroatoms, Independently selected from nitrogen, oxygen, selenium and sulphur.

Preferred examples of heteroaryl groups include, but are not limited to, pyridinyl, pyridazinyl, pyrimidyl, pyrazyl, triazinyl, pyrrolyl, pyrazolyl, Imidazolyl, (1,2,3,)- and (1,2,4)-triazolyl, pyrazinyl, pyrimidinyl, tetrazolyl, furyl, thienyl, isoxazolyl, thiazoyl, Isoxazolyl, and oxazolyl. A heteroaryl group can be unsubstituted or substituted with one, two or more suitable substituents. Preferably, a heteroaryl group is a monocyclic ring, wherein the ring comprises 1 to 5 carbon atoms and 1 to 4 heteroatoms.

The term substituted, in e.g. substituted alkyl group means that the alkyl group may be substituted by other atoms than the atoms normally present in such a group, i.e. carbon and hydrogen. For example, a substituted alkyl group may Include a halogen atom or a thiol group. An unsubstituted alkyl group contains only carbon and hydrogen atoms.

Unless otherwise specified a substituted alkyl group, a substituted alkenyl group, a substituted alkynyl group, a substituted aralkyl group, a substituted alkaryl group, a substituted aryl, a substituted heteroaryl and a substituted heterocyclic group are preferably substituted by one or more substituents selected from the group consisting of methyl, ethyl, n-propyl, isopropyl, n-butyl, 1-isobutyl, 2-isobutyl and tertiary-butyl, ester, amide, ether, thioether, ketone, aldehyde, sulfoxide, sulfone, sulfonate ester, sulphonamide, —Cl, —Br, —I, —OH, —SH, —CN and —NO₂.

### The Conducive Ink

The conductive ink according to the present Invention comprises metallic nanoparticles, a liquid carrier and an optional binder, characterized in that the liquid carrier includes between 0.5 and 7.5 wt %, preferably between 0.75 and 5 wt %, more preferably between 1 and 4 wt %, of a solvent selected from the group consisting of water and a polyol.

The conductive ink may further comprise a surfactant and other additives to further optimize its properties.

### Metallic Nanoparticles

The conductive ink of the present invention comprises metallic nanoparticles.

The metallic nanoparticles comprise one or more metals in elemental or alloy form. The metal Is preferably selected from the group consisting of silver, gold, copper, nickel, cobalt, molybdenum, palladium, platinum, tin, zinc, titanium, chromium, tantalum, tungsten, Iron, rhodium, iridium, ruthenium, osmium, aluminium and lead.

Metallic nanoparticles based on silver, copper, molybdenum, aluminium, gold, copper, or a combination thereof, are particularly preferred.

Most preferred are silver nanoparticles.

The term “nanoparticles” refers to dispersed particles having an average particle size or average particle diameter of less than 150 nm, preferably less than 100 nm, more preferably less than 50 nm, most preferably less than 30 nm. The average particle diameter referred to is determined with Transmission Electron Microscopy (TEM).

A conductive Ink, such as for example a silver Ink, may comprise primary particles and secondary particles. The latter may be aggregated primary particles. The particle diameter referred to above is the particle diameter of the primary particles.

The conductive ink preferably comprises at least 5 wt %, more preferably at least 10 wt %, most preferably at least 15 wt %, particularly preferred at least 20 wt %, of metallic nanoparticles, relative to the total weight of the dispersion.

### Liquid Carrier

The conductive ink comprises a liquid carrier including between 0.5 and 7.5 wt %, preferably between 0.75 and 5 wt %, more preferably between 1 and 4 wt %, of a solvent selected from water and a polyol.

A polyol is a compound comprising at least two hydroxyl groups.

The polyol is preferably selected from the group consisting of ethylene glycol, propylene glycol, butylene glycol, pentylene glycol, glycerol, and sorbitol.

The polyol is preferably glycerol.

The liquid carrier may include other organic solvents. The organic solvent may be selected from alcohols, aromatic hydrocarbons, ketones, esters, aliphatic hydrocarbons, dimethylsulfoxide (DMSO), higher fatty acids, carbitols, cellosolves, and higher fatty acid esters.

Suitable alcohols include methanol, ethanol, propanol, 1-butanol, 1-pentanol, 2-butanol, t-butanol.

Suitable aromatic hydrocarbons include toluene and xylene.

Suitable ketones include methyl ethyl ketone, methyl isobutyl ketone, 2,4-pentanedione and hexa-fluoroacetone.

Also glycolethers, N,N-dimethyl-acetamide, N,N-dimethylformamide may be used.

A mixture of organic solvents may be used to optimize the properties of the conductive ink.

Preferred organic solvents are high boiling solvents. High boiling organic solvents referred to herein are solvents which have a boiling point that is higher than the boiling point of water (>100° C.).

Preferred high boiling solvents are shown in Table 1.

TABLE 1

| | | Bp |
|---|---|---|
| Chemical formula | Chemical name | (° C.) |
| 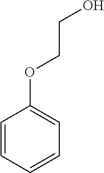 | 2-fenoxy ethanol (ethylene glycol monophenylether) | 247 |
| 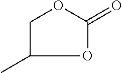 | 4-methyl-1,3-dioxolan-2-one (propylene carbonate) | 242 |
| 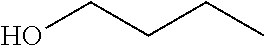 | n-butanol | 117 |
| 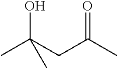 | 4-hydroxy-4-methylpentan-2- one (diaceton alcohol) | 168 |
| 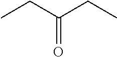 | Pentan-3-one (diethyl ketone) | 102 |
| 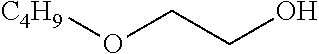 | 2-Butoxyethanol (Ethylene glycol monobutyl ether) | 171 |
| 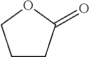 | Dihydrofuran-2(3H)-one (Gamma-butyrolacton) | 204 |
| 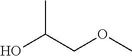 | 1-methoxy-2-propanol (propylene glycol monomethyl ether | 120 |
| 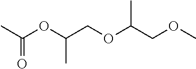 | Dowanol DPMA (Dipropyleenglycol methyl ether acetate) | 209 |
| 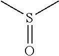 | dimethylsulfoxide | 189 |
| 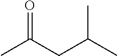 | Methyl isobutyl ketone | 119 |
| 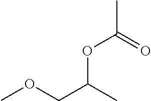 | Propylene glycol mono methyl ether acetate | 146 |

Particularly preferred high boiling solvents used in conductive inkjet Inks are 2-phenoxy-ethanol, propylene carbonate, n-butanol, gamma-butyro-lactone, and mixtures thereof.

Particularly preferred high boiling solvents are dimethylsulfoxide, 2-butoxy-ethanol, dipropylene glycol methyl ether acetate, methyl 5-(dimethylamino)-2-methyl-5-oxopentanoate and mixtures thereof.

Particularly preferred high boiling solvents used in conductive flexo and gravure printing Inks are methyl Isobutyl ketone, 2-butoxy-ethanol, propylene glycol mono methyl ether acetate, and mixtures thereof.

The liquid carrier may also comprise solvents which are used in the preparation method of the nanoparticles, such as those used in the methods disclosed in EP-A 2671927 and EP-A 2781562, for example 2-pyrrolidone.

It has been observed that silver inks wherein the liquid carrier comprises methyl-5-(dimethylamino)-2-methyl-5-oxopentananoate or methylbutyrolactone have improved sticking behavior and improved varnish stability.

The amount of the liquid carrier depends on the desired viscosity of the printing or coating fluid. The amount of the liquid carrier is preferably less than 95 wt %, more preferably less than 90 wt %, most preferably less than 85 wt % relative to the total weight of the conductive ink.

### Binder

The conductive ink may comprise a binder. The binder of the ink is preferably compatible with water or the polyol referred to above and at the same time compatible with the metallic nano-particles.

A water or polyol compatible binder referred to is a binder that is soluble in the solvent mixture of the conductive ink according to the present invention. Using a binder that is not compatible with water or polyol may result in a cloudy solution of the binder in the solvent mixture of the conductive ink, even at low concentrations of the binder or after stirring and/or heating the solution.

A binder that is not compatible with the metallic nano-particles may result in separation of part of the solvent from the conductive ink when shear is applied to the ink.

A test to determine whether or not a binder is water or polyol compatible and/or compatible with the metallic nano-particles is the following:
a small quantity of the conductive ink is applied between two transparent foils;
the ink is pressed between the foils with, for example, a roller or squeegee resulting in a spreading of the ink resulting in a thin layer of ink between the transparent foils.

When the binder Is not sufficiently compatible with water or polyol and/or with the metallic nano-particles, visual inspection of the thin Ink layer between the transparent foils may reveal areas consisting essentially of solvent, i.e. no or a minor amount of metallic nano-particles. Such areas are visible due to their lower density the result of a lower concentration of metallic nanoparticles.

In principle one type of binder can be selected, which is compatible with both water or the polyol and the metallic nano-particles. However, to enable optimization of other properties such as conductivity, adhesion, etc., it is preferred to use at least two different binders, i.e. a water or poyol compatible binder and a metallic nano-particle compatible binder.

The ratio of the water or poyol compatible binder to the metallic nano-particle compatible binder is preferably more than or equal to 7, more preferably more than or equal to 9.

The water or poyol compatible binder is preferably a water or poyol soluble binder.

Such a water or poyol soluble binder is preferably selected from the group consisting of polyvinylalcohol, polyvinylpyrrolidone, polyvinylacetate, sodium poly(styrenesulfonate), polyacrylic acid, gelatine, and mixtures thereof.

A metallic nano-particle compatible binder stabilizes the nano-particles In the Ink while fast and/or low temperature sintering of the printed nano-particles is still possible. Also, the binder preferably has a positive effect on the adhesion of the applied and sintered metallic pattern towards various substrates. In addition, the binder ensures a sufficient pot-life of the ink and homogeneous layers of ink while printing or coating.

A metallic nano-particle compatible binder is preferably a polyvinylchloride copolymer.

A particular preferred polyvinylchloride copolymer is a copolymer of vinyl chloride and a hydroxyfunctional monomer.

The hydroxyl functional monomer Is preferably selected from the group consisting of 2-hydroxypropyl acrylate, 1-hydroxy-2-propyl acrylate, 3-methyl-3-buten-1-ol, 2-methyl-2-propenoic acid 2-hydroxypropyl ester, 2-hydroxy-3-chloropropyl methacrylate, N-methylolmethacrylamide, 2-hydroxyethyl methacrylate, poly(ethylene oxide) monomethacrylate, glycerine monomethacrylate, 1,2-propylene glycol methacrylate, 2,3-hydroxypropyl methacrylate, 2-hydroxyethyl acrylate, vinyl alcohol, N-methylolacrylamide, 2-propenoic acid 5-hydroxypentyl ester, 2-methyl-2-propenoic acid, 3-chloro-2-hydroxypropyl ester, 1-hydroxy-2-propenoic acid, 1-methylethyl ester, 2-hydroxyethyl allyl ether, 4-hydroxybutyl acrylate, 1,4-butanediol monovinyl ether, poly(ε-caprolactone) hydroxyethyl methacrylate ester, poly(ethylene oxide) monomethacrylate, 2-methyl-2-propenoic acid, 2,5-dihydroxypentyl ester, 2-methyl-2-propenoic acid, 5,6-dihydroxyhexyl ester, 1,6-hexanediol monomethacrylate, 1,4-dideoxy-pentitol, 5-(2-methyl-2-propenoate), 2-propenoic acid, 2,4-dihydroxybutyl ester, 2-propenoic acid, 3,4-dihydroxybutyl ester, 2-methyl-2-propenoic acid, 2-hydroxybutyl ester, 3-hydroxypropyl methacrylate, 2-propenoic acid, 2,4-dihydroxybutyl ester, and isopropenyl alcohol.

The hydroxyl functional monomer is most preferably vinyl alcohol, 2-hydroxypropyl acrylate, 1-hydroxy-2-propyl acrylate, 4-hydroxybutyl acrylate, 2-hydroxyethyl methacrylate, 2-hydroxyethyl acrylate.

Examples of copolymers of vinyl chloride and a hydroxyfunctional monomer are chloroethylene-vinyl acetate-vinyl alcohol copolymer, vinyl alcohol-vinyl chloride copolymer, 2-hydroxypropyl acrylate-vinyl chloride polymer, propanediol monoacrylate-vinyl chloride copolymer, vinyl acetate-vinyl chloride-2-hydroxypropyl acrylate copolymer, hydroxyethyl acrylate-vinyl chloride copolymer, 2-hydroxyethyl methacrylate-vinyl chloride copolymer.

A particular preferred copolymer is a copolymer of vinyl chloride, vinyl acetate and a hydroxyfunctional monomer.

The amount of vinyl chloride is preferably more than or equal to 90 wt % relative to the total weight of the copolymer.

The Molecular Weight (MW) of the copolymer of vinyl chloride and a hydroxyfunctional monomer, measured with Gel Permeation Chromatograph (GPC) using polystyrene standards and THF as eluent, is preferably more than or equal to 15 000, more preferably more than or equal to 20 000.

The K value of the copolymer of vinyl chloride and a hydroxyfunctional monomer, measured according to ISO1628-2 (1998) is preferably more than or equal to 40, more preferably more than or equal to 45.

Suitable copolymers are for example Solbin® A, which is a copolymer of 92 wt % vinylchloride-3 wt % vinylacetate-5 wt % vinylalcohol, Solbin® AL, which is a copolymer of 93 wt % vinylchloride-2 wt % vinylacetate-5 wt % vinylalcohol, Solbin® TA2, which is a copolymer of 83 wt % vinylchloride-4 wt % vinylacetate-13 wt % hydroxyalkyl acrylate, Solbin® TA3 which is a copolymer of 83 wt % vinylchloride-4 wt % vinylacetate-13 wt % hydroxyalkylacrylate, Solbin® TAO, which is a copolymer of 91 wt % vinylchloride-2 wt % vinylacetate-7 wt % vinyl alcohol, all commercially available from Shin Etsu; Vinnol® E15/40 A, Vinnol® E 15/45 A, Vinnol® E 15/48 A, Vinnol® E 22/48 A, and Vinnol® H 5/50 A, all commercially available from Wacker Chemie; Sunvac® GH, which is a copolymer of 90 wt % vinylchloride-4 wt % vinylacetate-6 wt % vinyl alcohol, Sunvac® GF, which is a copolymer of 81 wt % vinylchoride-4 wt % vinylacetate-15 wt % hydroxylalkyl acrylate and Sunvac® DOH, which is a copolymer of 81 wt % vinylchloride-4 wt % vinylacetate-15 wt % hydroxylalkyl acrylate, all commercially available from Yantai Suny Chem International; S-Lec E4-HA commercially available from Sekisul; and VROH, LPOH and UMOH commercially available from Wuxi Honghui Chemical.

Another preferred binder Is a vinylidene chloride copolymer comprising 90 wt % or less of vinylidene chloride based on the total weight of the binder. When the amount of vinyldiene chloride is above 90 wt % based on the total weight of the binder, the crystallinity of the binder becomes too high resulting In a low solubility in the liquid carrier. Copolymerizaton of vinylidene chloride with further monomers renders the copolymer more amorphous and thus more soluble in the liquid carrier.

The vinylidene chloride copolymer preferably comprises a further monomer selected from the group consisting of vinyl chloride, alkyl acrylate, alkyl methacrylate, vinylether, vinylacetate, vinyl alcohol, acrylonitile, methacrylonitrile, maleic acid, maleic anhydride, Itaconic acid, Itaconic acid anhydride, and crotonic acid.

Suitable vinylidene chloride copolymers include: the copolymer of vinylidene chloride, N-tert.-butylacrylamide, n-butyl acrylate, and N-vinyl pyrrolidone (e.g. 70:23:3:4), the copolymer of vinylidene chloride, N-tert.-butylacrylamide, n-butyl acrylate, and itaconic acid (e.g. 70:21:5:2), the copolymer of vinylidene chloride, N-tert.-butylacrylamide, and itaconic acid (e.g. 88:10:2), the copolymer of vinylidene chloride, n-butylmaleimide, and itaconic acid (e.g. 90:8:2), the copolymer of vinyl chloride, vinylidene chloride, and methacrylic acid (e.g. 65:30:5), the copolymer of vinylidene chloride, vinyl chloride, and itaconic acid (e.g. 70:26:4), the copolymer of vinyl chloride, n-butyl acrylate, and Itaconic acid (e.g. 66:30:4), the copolymer of vinylidene chloride, n-butyl acrylate, and itaconic acid (e.g. 80:18:2), the copolymer of vinylidene chloride, methyl acrylate, and Itaconic acid (e.g. 90:8:2), the copolymer of vinyl chloride, vinylidene chloride, N-tert.-butylacrylamide, and Itaconic acid (e.g. 50:30:18:2). All the ratios given between brackets in the above-mentioned copolymers are ratios by weight.

Derivatives of maleic acid or maleic acid anhydride, such as for example the monomers according to Formulae a and b, may also be used as further monomer of the vinylidene chloride copolymer.

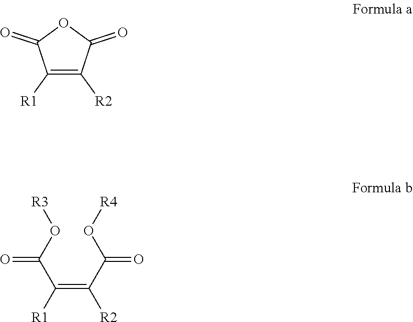

wherein

R1 to R4 represent a hydrogen atom, an optionally substituted alkyl group containing from 1 to 5 carbon atoms, or an optionally substituted alkenyl group containing from 1 to 5 carbon atoms.

Deriviates of succinic acid or succinic acid anhydride, such as for example the monomers according to Formulae III to VI, may also be used as further monomer of the vinylidene chloride copolymer.

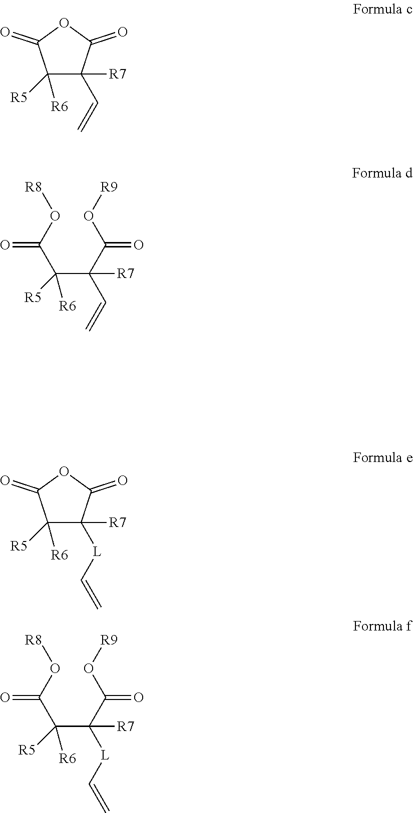

wherein

R5 to R9 represent a hydrogen atom, an optionally substituted alkyl group containing from 1 to 5 carbon atoms, or an optionally substituted alkenyl group containing from 1 to 5 carbon atoms;

L represents a linking group selected from the group consisting of an alkylene group containing from 1 to 5 carbon atoms, a polyethylene glycol containing up to 5 ethylene glycol units, or a polypropylene glycol containing up to 5 propylene glycol units.

A preferred monomer according to Formula c is 3-ethenyloxolane-2,5-dione; preferred monomers according to Formula d are 2-ethenylbutanedioic acid and 1,4-dimethyl 2-ethenylbutanedioate.

The vinylidene chloride copolymer more preferably comprises a further monomer selected from the group consisting of vinyl chloride, acrylonitrile, maleci acid, maleic anhydride and an alkyl acrylate.

The vinylidene chloride copolymer most preferably comprises from 40 to 90 wt % of vinylidene chloride, from 0.5 to 50 wt % of vinyl chloride and from 0.5 to 5 wt % of acrylonitrile.

The alkyl acrylate and alkyl methacrylate referred to above is preferably a C1-C10 alkyl acrylate or methacrylate. Particular preferred alkyl acrylates or alkyl methacrylates are methyl and butyl acrylate or methyl and butyl methacrylate.

A preferred example of a vinylidene chloride copolymer that may be used in the conductive ink according to the present invention is IXAN® SGA-1, commercially available from Solvay.

Other vinylidene copolymers that may be used are IXAN® PNE613, IXAN®PV910, IXAN9PV919, IXAN®PVS801, IXAN®PVS815, IXAN9PVS100 or IXAN®PV708, all commercially available from Solvay; F310, F218, R222B or R204, all available from Asahi Kasei Chemicals.

Water based vinylidene copolymers may also be used in the present invention.

Examples of such copolymers are Daran® 8730, Daran®8550, Daran®SL112, Daran®SL143, Daran®SL159 or Daran®8100, all commercially available from Owensboro Specialty Polymers; Diofan®193D, Diofan®P520, Dofan®P530 all commercially available from Solvay.

Two or more different binders may be used. For example, the vinylidene chloride copolymer described above may be combined with the vinylchloride copolymer described above.

The total amount of binder in the conductive ink is preferably between 0.1 and 15 wt %, more preferably between 0.2 and 7.5 wt %, most preferably between 0.25 and 5 wt %, particularly preferred between 0.5 and 3.0 wt %, relative to the total weight of the dispersion. When the amount of binder is too high, for example above 15 wt % relative to the total weight of the dispersion, the conductivity of the conductive ink tends to decrease. When the amount of binder is too low, for example less than 0.1 wt % relative to the total weight of the dispersion, no improvement in adhesion may be observed.

### Surfactants

The conductive ink preferably comprises a surfactant. Various surfactants may be used. However, it has been observed that the addition to the conductive ink of a surfactant selected from the group consisting of Disperbyk 2151, Disperbyk 2025, and Diserbyk 2155 results in a further Improvement of the adhesion of the dispersion, especially on ITO (Indium Tin Oxide) substrates. Particularly good results are obtained with Disperbyk-2151.

The amount of the surfactants is preferably between 0.01 and 10 wt %, more preferably between 0.05 and 5 wt %, most preferably between 0.1 and 1.0 wt %, relative to the total amount of the conductive ink.

### Adhesion Promoting Compound

It has been observed that the addition of adhesion promotoring compounds may further improve the adhesion towards various substrates.

For example the commercially available adhesion promoting compound Byk-4511 may Improve the adhesion, especially towards ITO (Indium Thin Oxide) substrates.

Particularly preferred adhesion promoting compounds are acidic polyesters. It has been observed that conductive inks comprising an acidic polyester are characterized by a substantial improved adhesion on ITO (Indium Thin Oxide) substrates.

The amount of the acidic polyester is preferably between 0.01 and 10 wt %, more preferably between 0.05 and 5 wt %, most preferably between 0.1 and 1.0 wt %, relative to the total amount of the conductive ink.

The acidic polyester is typically a copolymer with acidic groups having an acid value from 15 up to 100 mg KOH/g. Examples of commercially available acidic polyesters include BYK-4510 (commercially available from Byk Altana), PLUSOLIT H-PD (commercially available from MA der) or BORCHI GEN HMP-F (commercially available from OMG Borchers).

The acidic polyester is typically a polycondensate of a polyol and a polycarboxylic acid. The polyol and polycarboxylic acid are combined in desired proportions and chemically reacted using standard esterification (condensation) procedures to provide a polyester having both hydroxyl and carboxylic acid groups in the polyester resin. A triol Is typically used to provide a branched polyester.

Examples of suitable polycarboxylic acids or anhydrides include, but are not limited to, maleic anhydride, maleic acid, fumaric acid, itaconic acid, phthalic acid, phthalic anhydride, isophthalic acid, trimellitic anhydride, terephthalic acid, naphthalene dicarboxylic acid, adipic acid, azelaic acid, succinic acid, sebacic acid and various mixtures thereof.

Examples of suitable diols, triols and polyols include, but are not limited to, ethylene glycol, propylene glycol, 1,3-propanediol, glycerol, diethylene glycol, dipropylene glycol, triethylene glycol, trimethylolpropane, trimethylolethane, tri propylene glycol, neopentyl glycol, pentaerythritol, 1,4-butanediol, trimethylol propane, hexylene glycol, cyclohexane dimethanol, and polyethylene or polypropylene glycol.

A preferred polyol is trimethylolpropane, a preferred polycarboxylic acid is adipic acid

Other preferred acidic polyesters are the reaction product of

(a) a polyester having a Molecular Weight (Mn) of 2000 to 10 000, a hydroxyl number of 20 to 75, and an acid value of 15 to 25, the polyester being a condensate of:

(i) a polyol component comprising a mixture of diols and triols,

(ii) a polyacid component comprising an alpha, beta-ethylenically unsaturated polycarboxylic acid, and

(b) a phosphorus acid.

Further examples of phosphatised polyesters are disclosed in WO2012/162301.

### Dispersion-Stabilizing Compound (DSC)

The conductive ink according to the present invention may comprise a dispersion-stabilizing compound (DSC) according to Formulae VII, VIII, IX or X,

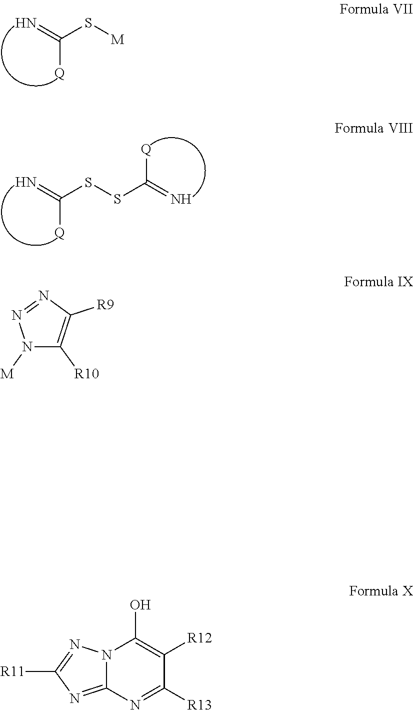

wherein

Q represents the necessary atoms to form a substituted or unsubstituted five or six membered heteroaromatic ring;

M is selected from the group consisting of a proton, a monovalent cationic group, an alkyl group, a heteroalkyl group and an acyl group;

R9 and R10 are independently selected from the group consisting of a hydrogen, a substituted or unsubstituted alkyl group, a substituted or unsubstituted alkenyl group, a substituted or unsubstituted alkynyl group, a substituted or unsubstituted alkaryl group, a substituted or unsubstituted aralkyl group, a substituted or unsubstituted aryl or heteroaryl group, a hydroxyl group, a thioether, an ether, an ester, an amide, an amine, a halogen, a ketone and an aldehyde;

R9 and R10 may represent the necessary atoms to form a five to seven membered ring;

R11 to R13 are Independently selected from the group consisting of a hydrogen, a substituted or unsubstituted alkyl group, a substituted or unsubstituted alkenyl group, a substituted or unsubstituted alkynyl group, a substituted or unsubstituted alkaryl group, a substituted or unsubstituted aralkyl group, a substituted or unsubstituted aryl or heteroaryl group, a hydroxyl group, a thiol, a thioether, a sulfone, a sulfoxide, an ether, an ester, an amide, an amine, a halogen, a ketone, an aldehyde, a nitrile and a nitro group;

R12 and R13 may represent the necessary atoms to form a five to seven membered ring.

The dispersion-stabilizing compound is preferably a compound according to Formula VII.

The dispersion-stabilizing compound is more preferably a compound according to Formula VII, wherein Q represents the necessary atoms to form a five membered heteroaromatic ring.

A particular preferred dispersion-stabilizing compound is a compound according Formula VI, wherein Q is a five membered heteroaromatic ring selected from the group consisting of an imidazole, a benzimidazole, a thiazole, a benzothiazole, an oxazole, a benzoxazole, a 1,2,3-triazole, a 1,2,4-triazole, an oxadiazole, a thiadiazole and a tetrazole.

Some examples of dispersion-stabilizing compounds are shown in the Table 2.

TABLE 2

| DSC | Chemical Formula |
|---|---|
| DCS-01 | 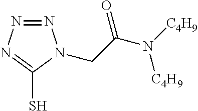 |
| DCS-02 | 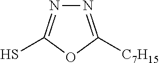 |
| DCS-03 | 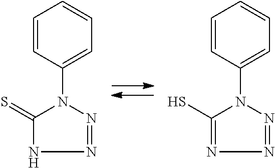 [SMILES: S=c1[nH]nnn1-c1ccccc1 ; Sc1nnnn1-c1ccccc1] |
| DCS-04 | 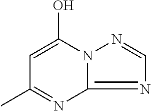 |
| DCS-05 | 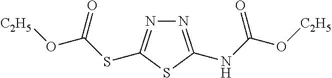 [SMILES: CCOC(=O)Nc1nnc(SC(=O)OCC)s1] |
| DCS-06 | 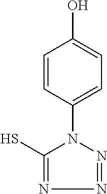 [SMILES: Oc1ccc(-n2nnnc2S)cc1] |
| DCS-07 | 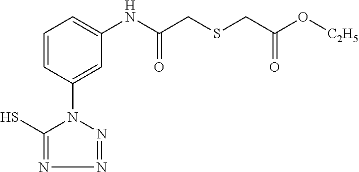 [SMILES: CCOC(=O)CSCC(=O)Nc1cccc(-n2nnnc2S)c1] |
| DCS-08 | 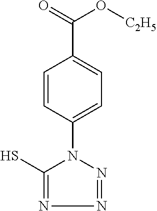 [SMILES: CCOC(=O)c1ccc(-n2nnnc2S)cc1] |
| DCS-09 | 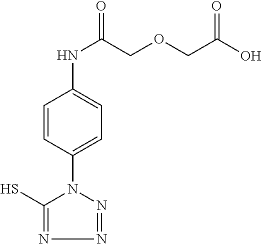 [SMILES: O=C(O)COCC(=O)Nc1ccc(-n2nnnc2S)cc1] |
| DCS-10 | 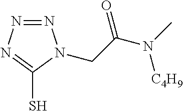 |
| DCS-11 | 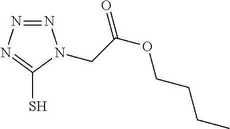 |
| DCS-12 | 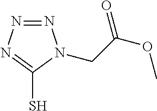 |
| DCS-13 | 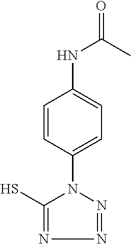 [SMILES: CC(=O)Nc1ccc(-n2nnnc2S)cc1] |
| DCS-14 | 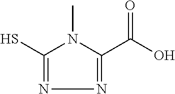 |
| DCS-15 | 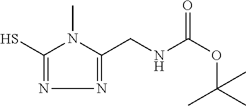 [SMILES: Cn1c(S)nnc1CNC(=O)OC(C)(C)C] |
| DCS-16 | 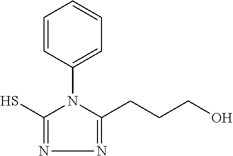 [SMILES: OCCCc1nnc(S)n1-c1ccccc1] |

The dispersion-stabilizing compound is preferably selected from the group consisting of N,N-dibutyl-(2,5-dihydro-5-thioxo-1H-tetrazol-1-yl-acetamide, 5-heptyl-2-mercapto-1,3,4-oxadiazole, 1-phenyl-5-mercaptotetrazol, 5-methyl-1,2,4-triazolo-(1,5-a) primidine-7-ol, and S-[5-[(ethoxycarbonyl)amino]-1,3,4-thiadiazol-2-yl] O-ethyl thiocarbonate.

The dispersion-stabilizing compounds according to Formula VII to X are preferably non-polymeric compounds. Non-polymeric compounds as used herein means compounds having a Molecular Weight which is less preferably than 1000, more preferably less than 500, most preferably less than 350.

The amount of the dispersion-stabilizing compounds (DSC) expressed as wt % relative to the total weight of silver (Ag) in the metallic nanoparticles is preferably between 0.005 and 10.0, more preferably between 0.0075 and 5.0, most preferably between 0.01 and 2.5. When the amount of the dispersion-stabilizing compound relative to the total weight of silver in the metallic nanoparticles is too low, the stabilizing effect may be too low, while a too high amount of the dispersion-stabilizing compound may adversely affect the conductivity of the coating or patterns obtained with the conductive ink.

### Additives

To optimize the coating or printing properties, and also depending on the application for which it is used, additives such as reducing agents, wetting/levelling agents, dewetting agents, rheology modifiers, adhesion agents, tackifiers, humectants, jetting agents, curing agents, biocides or antioxidants may be added to the conductive ink described above.

It may be advantageous to add to the conductive ink a small amount of an inorganic acid or a compound capable of generating such an acid during curing of a metallic layer or pattern formed from the conductive ink such as disclosed in EP-A 2821164. Higher conductivities and/or lower curing temperatures were observed of layers or patterns formed from such conductive inks.

Higher conductivities and/or lower curing temperatures may also be obtained when using metallic nanoparticles dispersions containing a compound according to Formula XI, as disclosed in WO2015/000937.

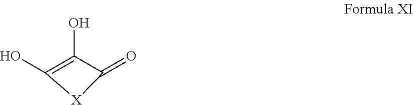

wherein

X represents the necessary atoms to form a substituted or unsubstituted ring.

A particularly preferred compound according to Formula XI is an ascorbic or erythorbic acid derivative compound.

A thickening agent may be added to Increase the viscosity of the printing or coating fluid. Preferred thickening agents may be selected from amorphous silica, polyvinylpyrrolidones having different Molecular Weights, and cellulose based thickening agents. A particular preferred thickening agent is hydroxypropylcellulose.

### Preparation of the Conductive Ink

The preparation of the conductive ink according to the present invention typically comprises the addition of the liquid carrier, the optional binder and optional additives to the metallic nanoparticles by using a homogenization technique such as stirring, high shear mixing, ultra-sonication, or a combination thereof.

The metallic nanoparticles from which the conductive ink is made is typically a paste or a highly concentrated dispersion of metallic nanoparticles. A preferred preparation method of the metallic nanoparticles Is described below.

The homogenization step can be carried out at elevated temperature up to 100° C. In a preferred embodiment, the homogenization step Is carried out at temperature equal or below 60° C.

In a preferred embodiment, the conductive ink is used In an Inkjet printing method. Such a conductive ink, also referred to as metallic inkjet fluid or ink or conductive inkjet fluid or ink, preferably has a viscosity lower than 35 mPa·s, preferably lower than 28 mPa·s, and most preferably between 2 and 25 mPa·s at 25° C. and measured at a shear rate of 90 s⁻¹.

When using so-called throughflow printheads, the viscosity of the metallic inkjet fluid may be higher, preferably below 60 mPa·s at 25° C. and at a shear rate of 90 s⁻¹. A higher viscosity limit for the metallic Inkjet fluid opens up more compositional variations of the fluid which may be advantageous towards more concentrated and/or more stable metallic inkjet fluids

In another preferred embodiment, the conductive ink is used in a flexographic printing process. Such a conductive ink, also referred to as metallic flexo ink or conductive flexo ink, preferably has a viscosity between 10 and 200 mPa·s, more preferably between 25 and 150 mPa·s, most preferably between 50 and 100 mPa·s measured at 25° C. and at a shear rate of 90 s⁻¹.

In another preferred embodiment, the conductive Ink Is used in a screen printing process. Such a conductive ink, also referred to as metallic screen ink or conductive screen ink, preferably has a viscosity between 3000 and 1000000 mPa·s, most preferably between 5000 and 750000 mPa·s, most preferably between 10000 and 500000, measured at 25° C. and at a shear rate of 1 s⁻¹.

### Metallic Layers or Patterns

Thin layers or patterns printed or coated from the conductive ink can be rendered conductive at lower sintering temperatures compared to those obtained with conventional metallic printing or coating fluids. Therefore, conductive thin layers or patterns made from the metallic printing or coating fluids of the present invention can be coated or printed on flexible supports that can not withstand thermal treatment at high temperature, such as for example PET.

The metallic layers or patterns are prepared by a method comprising the steps of applying a conductive ink as defined above on a support followed by a sintering step.

The support may a glass, a paper or a polymeric support.

Preferred polymeric supports are polycarbonate, polyethylene terephthalate (PET) or polyvinylchloride (PVC) based supports. A preferred PET support is for example an AUTOSTAT™ heat stabilized polyester from MacDermid.

The above mentioned supports may be provided with one or more layers to improve the adhesion, absorption or spreading of the applied conductive inkjet, screen or flexo inks.

Polymeric supports are preferably provided with so-called subbing layers to improve the adhesion of the applied conductive inkjet, screen or flexo inks. Such subbing layers are typically based on vinylidene copolymers, polyesters, or (meth)acrylates.

Useful subbing layers for this purpose are well known in the art and Include, for example, polymers of vinylidene chloride such as vinylidene chloride/acrylonitrile/acrylic acid terpolymers or vinylidene chloride/methyl acrylate/itaconic acid terpolymers.

Other preferred subbing layers include a binder based on a polyester-urethane copolymer. In a more preferred embodiment, the polyester-urethane copolymer is an ionomer type polyester urethane, preferably using polyester segments based on terephthalic acid and ethylene glycol and hexamethylene diisocyanate. A suitable polyester-urethane copolymer is Hydran™ APX101 H from DIC Europe GmbH.

The application of subbing layers is well-known in the art of manufacturing polyester supports for silver halide photographic films. For example, the preparation of such subbing layers is disclosed in U.S. Pat. No. 3,649,336 and GB 1441591.

An acid generating compound may be Incorporated in a primer layer on a support as disclosed in WO2015/000932. A preferred primer comprises a copolymer of vinylidene chloride, an acrylic ester and Itaconic acid.

In a preferred embodiment, the subbing layer has a dry thickness of no more than 0.2 μm or preferably no more than 200 mg/m².

Another preferred support is a support based on transparent conductive oxides. Such a support is typically a glass or polymer support whereupon a layer or pattern of a transparent conductive oxide (TCO) is provided. Examples of such conductive oxides are ITO (Indium Tin Oxide), ZnO, SnO₂ or doped oxides such as ZnO:Al. A particularly preferred TCO is ITO.

A preferred paper based support is the Powercoat® paper substrate, a substrate designed for printed electronics by Arowiggins Creative Papers.

Multiple metallic layers or patterns, i.e. a stack of patterned or unpatterned layers, may be applied on a substrate. The support referred to in the method of preparing the metallic layers or patterns thus also encompass a previously applied metallic layer or pattern.

Metallic layers may be provided onto a support by co-extrusion or any conventional coating technique, such as dip coating, knife coating, extrusion coating, spin coating, spray coating, blade coating, slot die coating, slide hopper coating and curtain coating.

Metallic layers and in particular metallic patterns may be provided onto a support by a printing method such as Intaglio printing, screen printing, flexographic printing, offset printing, inkjet printing, gravure offset printing, etc.

Preferred printing methods are an inkjet, screen printing and flexographic printing method.

Another method to provide a metallic layer or pattern on a support is aerosol jet printing. Aerosol Jet Printing, which has been developed by Optomec, preserves most of the advantages of inkjet printing, while reducing many of its limitations. The technique is developed for use in the field of printed electronics. The technique is disclosed in for example US2003/0048314, US2003/0020768, US2003/0228124 and WO2009/049072. An Aerosol Jet Print Engine Is commercially available from Optomec, for example the Aerosol Jet Printer OPTOMEC AJ 300 CE.

Virtually any liquid having a viscosity less than 5000 mPa·s can be deposited using the Aerosol Jet Printing technique. Using higher viscous fluids may be advantageous with respect to the stability of the metallic inks

### Curing Step

After the layers or patterns are applied on the support, a sintering step, also referred to as curing step, is carried out. During this sintering step, solvents evaporate and the metallic particles sinter together. Once a continuous percolating network is formed between the metallic particles, the layers or patterns become conductive. Conventional sintering is typically carried out by applying heat. The sintering temperature and time are dependent on the support used and on the composition of the metallic layer or pattern. The sintering step for curing the metallic layers may be performed at a temperature below 250° C., preferably below 200° C., more preferably below 180° C., most preferably below 160° C.

The sintering time may be less than 60 minutes, preferably between 2 and 30 minutes and more preferably between 3 and 20 minutes, depending on the selected temperature, support and composition of the metallic layers.

However, instead of or in addition to the conventional sintering by applying heat, alternative sintering methods such as exposure to an Argon laser, to microwave radiation, to IR radiation, to UV radiation or to low pressure Argon plasma, photonic curing, plasma or plasma enhanced, electron beam, laser beam or pulse electric current sintering may be used. When using pulse electric current sintering, the electric current may be directly applied to the conductive ink or indirectly via induction.

Another curing method uses the so-called Near InfraRed (NIR) curing technology. The metal of the coating or the pattern, for example silver, may act as absorber for the NIR radiation.

Still another curing method uses heated steam instead of hot air temperature curing which also efficiently heats up and sinters the metal of the coating or the pattern.

The metallic layers of the present invention allow to use lower curing temperatures than the prior art processes. In consequence it is possible to use polymeric substrates that can not withstand thermal treatment at high temperature, such as for example PET.

The curing time may also be substantially reduced leading to the possibility of having higher production per hour than the prior art processes. The conductivity of the metallic layers are maintained or even Improved in certain cases.

To further increase the conductivity or to lower the curing temperature it may be advantageous to contact the metallic layer or pattern with a solution containing an acid or an acid precursor capable or releasing the acid during curing of the metallic layer or pattern, as disclosed in WO2015/000932.

The metallic layers or patterns may be used in various electronic devices or parts of such electronic devices as for example organic photo-voltaics (OPV's), Inorganic photo-voltaics (c-Si, a-Si, CdTe, CIGS), OLED displays, OLED lighting, inorganic lighting, RFID's, organic transistors, thin film batteries, touch-screens, e-paper, LCD's, plasma, sensors, membrane switches or electromagnetic shielding.

### Preparation of the Metallic Nanoparticles

The metallic nanoparticle according to the present invention may be prepared by any known preparation method.

A particularly preferred method to prepare the metallic nanoparticles is disclosed in EP-A 2781562.

The conductive Ink obtained by the method disclosed in EP-A 2781562 typically contains at least 15 wt %, more preferably at least 30 wt %, most preferably at least 50 wt % of metallic nanoparticles, relative to the total weight of the dispersion. This highly concentrated dispersion is then used to prepare the conductive ink according to the present invention as described above.

### EXAMPLES

### Materials

All materials used in the following examples were readily available from standard sources such as ALDRICH CHEMICAL Co. (Belgium) and ACROS (Belgium) unless otherwise specified. The water used was deionized water.

Silver oxide (Ag₂O) was prepared by the precipitation of silver nitrate in an alkaline aqueous solution of sodium hydroxide (33 wt %) followed by filtration and drying.

Sobin® A is a copolymer of 92 wt % vinylchloride, 3 wt % vinylacetate, and 5 wt % vinylalcohol commercially available from SHIN ETSU.

Aquatreat Ar7H Is a 15 wt % aqueous solution of high molecular polyacrylic acid.

NaPSS is a 30 wt % dispersion in water of Versa TL130.

Versa TL130 is a sodium salt of polystyrene sulfonate, available from ALCO CHELICALS.

Butyl Cellosolve (CASRN 111-76-2) is ethylene glycol monobutylether commerically available from MERCK.

Efka FL3277 (CASRN 849624-75-5) is a wetting agent commercially available from BASF.

Diperbyk 2151 is a wetting agent commercially available from BYK (ALTANA).

Byk 4510 is an adhesion promoting compound commercially available from BYK (ALTANA).

Rhodiasolv® PolarClean is 5-(dimethylamino) 2-methyl 5-oxopentanoate commercially available from SOLVAY.

Rhodiasolv® RPDE is a mixture of di-methylesters of C4-6 aliphatic diacids: CH3-O—C—(CH2)n-C—O—CH3 Dimethyl succinate 20-28% Dimethyl glutarate 59-67% Dimethyl adipate 9-17% commercially available from SOLVAY.

Rhodiasolv® IRIS is methyl glutaric acid dimethyl ester commercially available from SOLVAY.

PET is a polyethyleneterephthalate support (163 μm) from AGFA GEVAERT.

Subbed PET Is PET having on both sides a primer. The primer, coated from an aqueous coating solution, has a composition according to the following Table 3.

TABLE 3

| Ingredients | Amount (mg/m²) |
|---|---|
| Copol (ViCI2-MA-IA) | 151.00 |
| Kieselsol 100 F | 35.00 |
| Mersolat H40 | 0.75 |

Copol (ViCl₂-MA-IA) is a copolymer of vinylidenechloride-methacrylic acid and itaconic acid from AGFA GEVAERT.

Mersolat H40 is a surfactant from LANXESS.

Kieselsol 100F is a silica from BAYER.

Autostat CT7 is a 175 μm heat stabilized polyester support from MACDERMID.

Polycarbonate is a 250 μm polycarbonate sheet (Lexan 8A73) available from TEKRA.

Geniosil GF96 is 3-aminopropyltrimethoxysilane commercially available from WACKER.

Silquest A-1524 is a gamma-ureido-propyltrimethoxysilane commercially available from MOMENTIVE.

Dynasylan Glymo is 3-glycidyloxypropyltrimethoxysilane commercially available from EVONIK.

Geniosil GF9 is N-(2-aminoethyl)-3-aminopropyttrimethoxysilane commercially available from WACKER.

### Measurements Methods

### Screen Printing

Screen printing of silver inks on a Autostat CT7 substrate was performed using a screen mesh as specified in the examples and a Capillex CP stencil film (available from MACDERMID AUTOTYPE) on a RokuPrint RP2.2 screen printing equipment.

Screen mesh tension was 27 N/cm, print speed 300 mm/s. A Unitex 80° Shore A squeegee was used with an angle of 75° with reference to the screen mesh. A metallic flood bar was used with an angle of 90° and distance of approximately 175 μm with reference to the screen mesh. The distance of the screen mesh to the substrate was 2.5 mm. The squeegee pressure was minimized to a minimum level where ink is still adequately printed on the substrate

A pattern with a dimension of approximately 6.0×4.5 cm was printed to measure full surface conductivity of the printed layer.

A pattern of 5 cm length lines with a nominal print width of 100, 200 and 500 μm was printed parallel and perpendicular to the printing direction to measure printed line properties

Printed substrates were drying during 3 minutes at a temperature of 130° C. in a box oven.

Curing of the dried prints was performed in a box oven during 15 minutes at a temperature of 150° C.

### Conductivity of the Silver Coatings

The surface resistance (SER) of the silver coatings was measured using a four-point collinear probe. The surface or sheet resistance was calculated by the following formula:

SER=(π/In2)*(V/I)

wherein

SER is the surface resistance of the layer expressed in Ω/square;

π is a mathematical constant, approximately equal to 3.14;

In2 is a mathematical constant equal to the natural logarithmic of value 2;

V is the voltage measured using the four-point probe measurement device;

I is the source current measured by the four-point probe measurement device.

For each sample, six measurements were performed at different positions of the coating and the average value was calculated.

The silver content M_{Ag} (g/m²) of the coatings was determined by WD-XRF.

The conductivity of the coated layers was then determined by calculating the conductivity as a percentage of the bulk conductivity of silver using the following formula:

$$\% {Ag}_{( b u l k )} = \frac{{σ}_{C o a t}}{{σ}_{A g}} \times 100$$

$$\% {Ag}_{( bulk )} = \frac{{ρ}_{A g}}{{σ}_{A g} \times S E R \times {M}_{A g}} \times 100$$

wherein σ_{Ag} the specific conductivity of silver (equal to 6.3×10⁷ S/m), σ_{Coat} is the specific conductivity of the Ag coating and ρ_{Ag} is the density of silver (1.049×10⁷ g/m³).

### Resolution

The width of printed silver lines are evaluated with an USB digital microscope (eScope Mirazoom MS902 available from CONRAD).

The nominal width (N) of the line openings on the screen stencil was 100 μm, 200 μm and 500 μm.

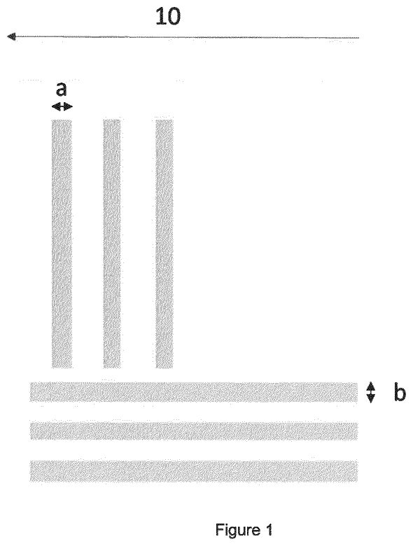

The so-called widening and smearing of the printed silver lines were measured as schematically shown in FIG. 1.

The width of printed silver lines parallel (b) and perpendicular (a) to the printing direction (10) was measured using the USB digital microscope described above.

The widening (W) and the smearing (S) were calculated as follows:

widening (W)=b−N

smearing (S)=a−b−W

W, S, a and b are all in μm.

### Adhesion

The adhesion of the silver coatings on different substrates has been evaluated by a tape test according to ASTM D3359. The evaluation results in a score from 0 (very good adhesion) to 5 (very bad adhesion).

### Dynamic Viscosity

Dynamic viscosities were measured with a HAAKE™ RotoVisco™ Rotational Reometer, commercially available from Thermo Fisher Scientific at 25° C.

### Example 1

### Preparation of the Silver Nanoparticle Dispersion NPD-01

78.0 g of silver oxide was slowly added, while stirring, to a 1 l reactor containing 275.0 g of pentanoic acid and 401.0 g of 2-pyrrolidone. The temperature of the mixture was kept at 25° C.

After complete addition of the silver oxide, the suspension was stirred overnight at 25° C.

Then, 300.0 g of N,N-diethylhydroxylamine was added in a time span of 1.5 hours to the suspension. The temperature of the reaction mixture was kept at 25° C. When all reducing agent was added, the reaction mixture was kept at 25° C. while stirring for another hour.

The reaction mixture is then fed to a sedimentation vessel, where it was kept overnight, without stirring. The supernatant was carefully removed from the sediment.

The obtained sediment was washed four times, two times with Dowanol PM™ (547 g) and two times with Butylcellosolve™ (547 g). In each washing step, the solvent was added to the sediment and the resulting suspension stirred for 0.5 hour at 300 rpm. Then, the unstirred suspension was kept for another hour, and the supernatant carefully removed.

After the last washing step with Butylcellosolve™, the sediment was centrifuged, in a centrifugal decanter from Rousselet Robatel (France) at 3000 rpm during 0.5 hour.

The obtained silver nanopartile dispersion NPD-01 had t 75 wt % of silver, relative to the total weight of the dispersion.

### Preparation of the Silver Inks SI-01 to SI-06

The Silver Inks SI-01 to SI-06 were prepared by mixing together while stirring the non-silver ingredients of Table 4 until a clear solution was obtained. The silver nanoparticle dispersion NPD-01 was then added to the clear solution, followed by high shear homogenization.

TABLE 4

| Ingredient (wt %) | SI-01 | SI-02 | SI-03 | SI-04 | SI-05 | SI-06 |
|---|---|---|---|---|---|---|
| Solbin A | 2.18 | = | = | = | = | = |
| Aquatreat Ar7H | 0.7 | = | = | = | = | = |
| Rhodiasolv Polarclean | 7.71 | = | = | = | = | = |
| Byk-4510 | 0.2 | = | = | = | = | = |
| Disperbyk 2151 | 0.71 | = | = | = | = | = |
| Efka FL3277 | 0.33 | = | = | = | = | = |
| Butylcellosolve | 11.0 | 10.0 | 9.0 | 8.0 | 7.0 | 3.0 |
| Water | — | 1.0 | 2.0 | 3.0 | 4.0 | 8.0 |
| NPD-01 | 77.2 | = | = | = | = | = |

### Evaluation of the Silver Inks SI-01 to Si-06

The Silver inks SI-01 to SI-06 were screen printed as described above using a P180-27 screen mesh (available from PUBLIVENOR, Belgium and coated with Capillex CP Stencil film, available from MacDermid).

The conductivity and the resolution of the printed silver inks SI-01 to SI-06 were measured as described above. The results are shown in Table 5.

TABLE 5

| | | Resolution | | |
|---|---|---|---|---|
| Silver Ink | % Ag-bulk | W | S | W + S |
| SI-01 (COMP) | 36 | 32 | 12 | 44 |
| SI-02 (INV) | 36 | 13 | 14 | 27 |
| SI-03 (INV) | 33 | 10 | 10 | 20 |
| SI-04 (INV) | 35 | 13 | 7 | 20 |
| SI-05 (INV) | 34 | 4 | 13 | 16 |
| SI-06 (COMP) | — (*) | — | — | — |

(*) too much agglomerates

From the results In Table 5 It is clear that both the widening and the smearing of the printed silver lines are less for the inventive silver inks (SI-02 to SI-05) comprising water as solvent in amount between 0.5 and 7.5 wt %, relative to the total weight of the silver Ink compared to those of the comparative silver inks SI-01 and SI-06.

### Example 2

### Preparation of the Silver Inks SI-07 to SI-15

The Silver Inks SI-07 to SI-15 were prepared by mixing together while stirring the non-silver Ingredients of Table 6 until a clear solution was obtained. The silver nanoparticle dispersion NPD-01 was then added to the clear solution, followed by high shear homogenization.

TABLE 6

| Ingredient (wt %) | SI-07 | SI-08 | SI-09 | SI-10 | SI-11 |
|---|---|---|---|---|---|
| Solbin A | 2.66 | = | = | = | = |
| Rhodiasolv Polarclean | 8.32 | 6.82 | 7.76 | 6.26 | 4.76 |
| Byk-4510 | 0.57 | = | 1.13 | = | — |
| Disperbyk 2151 | 0.86 | = | = | = | = |
| Efka FL3277 | 0.4 | = | = | = | = |
| Glycerol | — | 1.5 | — | 1.5 | 3.0 |
| Rhodiasolv RPDE | — | — | — | — | — |
| Rhodiasolv IRIS | — | — | — | — | — |
| NPD-01 | 87.2 | = | = | = | = |

| Ingredient (wt %) | SI-12 | SI-13 | SI-14 | SI-15 |
|---|---|---|---|---|
| Solbin A | 2.36 | 2.36 | 2.66 | 2.66 |
| Rhodiasolv Polarclean | 4.72 | 4.22 | — | — |
| Byk-4510 | 0.76 | = | 0.86 | = |
| Disperbyk 2151 | 0.84 | 0.83 | = | = |
| Efka FL3277 | 0.35 | 0.35 | 0.40 | 0.40 |
| Glycerol | 2.66 | 2.66 | — | — |
| Rhodiasolv RPDE | — | — | 8.32 | — |
| Rhodiasolv IRIS | — | — | — | 8.32 |
| NPD-01 | 77.3 | = | 87.2 | = |

### Evaluation of the Silver Inks SI-07 to SI-15

The Silver inks SI-07 to SI-15 were screen printed as described above using a V380-23/EOM 5μ screen mesh (available from PVF GmbH, Germany and coated with a 5 μm thick emulsion GBF444, available from PVF GmbH, Germany).

The conductivity and the resolution of the printed silver inks SI-07 to SI-15 were measured as described above. The results are shown in Table 7.

TABLE 7

| | | Resolution | | |
|---|---|---|---|---|
| Silver Ink | % Ag-bulk | W | S | W + S |
| SI-07 (COMP) | 28 | 11 | 17 | 28 |
| SI-08 (INV) | 16 | −17 | 16 | −1 |
| SI-09 (COMP) | 28 | 14 | 14 | 28 |
| SI-10 (INV) | 16 | 6 | −1 | 5 |
| SI-11 (INV) | 2 | −32 | 23 | −9 |
| SI-12 (INV) | 15 | 15 | 2 | 16 |
| SI-13 (INV) | 16 | 13 | −3 | 9 |
| SI-14 (COMP) | 28 | 11 | 22 | 34 |
| SI-15 (COMP) | 28 | 15 | 15 | 30 |

From the results in Table 7 it is clear that the sum of the widening and the smearing of the printed silver lines are less for the inventive silver comprising glycerol as solvent in amount between 0.5 and 7.5 wt %, relative to the total weight of the silver Ink compared to those of the comparative silver Inks.

### Example 3

### Preparation of the Silver Inks SI-16 to SI-24

The Silver Inks SI-016 to SI-24 were prepared by mixing together while stirring the non-silver ingredients of Table 8 until a clear solution was obtained. The silver nanoparticle dispersion NPD-01 was then added to the clear solution, followed by high shear homogenization.

TABLE 8

| Ingredient (wt %) | SI-16 | SI-17 | SI-18 | SI-19 | SI-20 |
|---|---|---|---|---|---|
| Solbin A | 2.40 | = | = | = | — |
| Rhodiasolv Polarclean | 7.01 | = | = | = | 11.57 |
| Byk-4510 | 0.24 | = | = | = | = |
| Disperbyk 2151 | 0.78 | = | = | = | = |
| Efka FL3277 | 0.36 | = | = | = | = |
| Butylcellosolve | 9.00 | — | — | — | — |
| Gamma-butyrolactone | — | 9.00 | — | — | — |
| 1,2-propanediol | — | — | 9.00 | — | — |
| 1,5-pentanediol | — | — | — | 9.00 | — |
| NPD-01 | 80.2 | = | = | = | 84.60 |

| Ingredient (wt %) | SI-21 | SI-22 | SI-23 | SI-24 |
|---|---|---|---|---|
| Solbin A | 2.40 | = | 2.55 | 2.40 |
| Rhodiasolv Polarclean | 7.01 | = | 7.04 | 7.01 |
| Byk-4510 | 0.24 | = | = | = |
| Disperbyk 2151 | 0.78 | = | 0.83 | 0.78 |
| Efka FL3277 | 0.36 | = | 0.38 | = |
| Octanol | 9.00 | — | — | — |
| Dowanol TPM | — | 9.00 | — | — |
| Glycerol | — | — | 3.60 | — |
| 1-heptanol | — | — | — | 9.00 |
| NPD-01 | 80.2 | = | 85.3 | 80.2 |

### Evaluation of the Silver Inks SI-16 to SI-24

The Silver inks SI-16 to SI-24 were screen printed as described above using a P180-27 screen mesh (available from Publivenor, Belgium and coated with Capillex CP stencil film, available from MacDermid).

The conductivity and the resolution of the printed silver Inks SI-16 to SI-24 were measured as described above. The results are shown In Table 9.

TABLE 9

| | | Resolution | | |
|---|---|---|---|---|
| Silver Ink | % Ag-bulk | W | S | W + S |
| SI-16 (COMP) | 34 | 18 | 22 | 40 |
| SI-17 (COMP) | 29 | −7 | 37 | 30 |
| SI-18 (INV) | 37 | −14 | 1 | −13 |
| SI-19 (INV) | 38 | −9 | 25 | 16 |
| SI-20 (COMP) | 37 | −11 | 42 | 31 |
| SI-21 (COMP) | 36 | 21 | 21 | 42 |
| SI-22 (COMP) | 35 | 64 | 13 | 77 |
| SI-23 (INV) | 19 | −4 | 16 | 11 |
| SI-24 (COMP) | 36 | 49 | 18 | 67 |

From the results in Table 9 it is clear that both the widening and the smearing of the printed silver lines are less for the Inventive silver Inks (SI-18, SI-19 and SI-23) comprising a solvent selected from water, glycerol or an alcohol comprising at least two hydroxyl groups in amount between 0.5 and 7.5 wt %, relative to the total weight of the silver ink compared to those of the comparative silver inks.

### Example 4

### Preparation of the Silver Inks SI-25 to SI-33

The Silver Inks SI-25 to SI-33 were prepared by mixing together while stirring the non-silver ingredients of Table 10 until a clear solution was obtained. The silver nanopartile dispersion NPD-01 was then added to the clear solution, followed by high shear homogenization.

TABLE 10

| Ingredient (wt %) | SI-25 | SI-26 | SI-27 | SI-28 | SI-29 |
|---|---|---|---|---|---|
| Solbin A | 2.35 | 2.18 | = | = | = |
| NaPSS | — | 4.3 | = | = | = |
| Rhodiasolv Polarclean | 9.0 | 7.71 | 11.21 | = | 7.71 |
| Byk-4510 | 0.24 | = | = | = | = |
| Disperbyk 2151 | 0.76 | 0.71 | = | = | = |
| Efka FL3277 | 0.35 | 0.33 | = | = | = |
| Butylcellosolve | 4.4 | 5.4 | 1.9 | = | 3.4 |
| water | — | 2.0 | 2.0 | — | — |
| 1,2-propanediol | — | — | — | 2.0 | — |
| Water/1,2-propanediol (1:1) | — | — | — | — | 4.0 |
| NPD-01 | 77.9 | 77.1 | = | = | 84.60 |

| Ingredient (wt %) | SI-30 | SI-31 | SI32 | SI-33 |
|---|---|---|---|---|
| Solbin A | 2.40 | = | 2.55 | 2.40 |
| NaPSS | 4.3 | 4.3 | — | — |
| Rhodiasolv Polarclean | 9.21 | 7.71 | 14.51 | 7.71 |
| Byk-4510 | 0.24 | 0.2 | = | = |
| Disperbyk 2151 | 0.71 | = | = | = |
| Efka FL3277 | 0.33 | = | = | = |
| Butylcellosolve | 1.9 | = | = | 8.7 |
| Water/1,2-propanediol (1:1) | 4.0 | — | — | — |
| 1,2-propanediol | — | 5; 5 | — | — |
| Water | — | — | 3.0 | — |
| NPD-01 | 80.2 | = | 85.3 | 80.2 |

### Evaluation of the Salver Inks SI-25 to SI-33

The Sliver Inks SI-25 to SI-33 were screen printed as described above using a P180-27 screen mesh (available from Publivenor, Belgium and coated with Capillex CP stencil film, available from MacDermid).

The conductivity and the resolution of the printed silver inks SI-25 to SI-33 were measured as described above. The results are shown in Table 11.

TABLE 11

| | | Resolution | | |
|---|---|---|---|---|
| Silver Ink | % Ag-bulk | W | S | W + S |
| SI-25 (COMP) | 53 | 24 | 26 | 50 |
| SI-26 (INV) | 32 | 4 | 8 | 11 |
| SI-27 (INV) | 33 | 8 | 11 | 19 |
| SI-28 (INV) | 28 | 12 | 14 | 26 |
| SI-29 (INV) | 25 | 11 | 14 | 25 |
| SI-30 (INV) | 43 | 15 | 21 | 36 |
| SI-31 (INV) | 37 | 9 | 13 | 21 |
| SI-32 (INV) | 23 | 10 | 14 | 24 |
| SI-33 (INV) | 42 | 13 | 18 | 31 |

From the results in Table 11 it is clear that both the widening and the smearing of the printed silver lines are less for the Inventive silver inks (SI-26 to SI-33) comprising a solvent selected from water or an alcohol comprising at least two hydroxyl groups In amount between 0.5 and 7.5 wt %, relative to the total weight of the silver ink, compared to those of the comparative silver Ink.

1-15. (canceled)

16. A conductive ink comprising metallic nanoparticles, a liquid carrier, and an optional binder, wherein the liquid carrier comprises from 0.5 to 7.5 wt % of a solvent selected from the group consisting of water, a polyol, and combinations thereof.

17. The conductive ink according to claim 16, wherein the solvent is a polyol selected from the group consisting of ethylene glycol, propylene glycol, butylene glycol, pentylene glycol, glycerol, sorbitol, and combinations thereof.

18. The conductive ink according to claim 16, wherein the solvent is water or glycerol.

19. The conductive ink according to claim 16, comprising a water or polyol compatible binder and a metallic nanoparticle compatible binder.

20. The conductive ink according to claim 19, wherein the water or polyol compatible binder is a water or polyol soluble binder.

21. The conductive ink according to claim 19, wherein the metallic nanoparticle compatible binder is a polyvinylchloride copolymer or a polyvinylidenechloride copolymer.

22. The conductive ink according to claim 21, wherein the polyvinylchloride copolymer is a copolymer of vinyl chloride and a hydroxyfunctional monomer.

23. The conductive ink according to claim 19, wherein the binder is from 0.2 to 7.5 wt % of the ink.

24. The conductive ink according to claim 19, wherein the ratio of water or polyol compatible binder to metallic nanoparticle compatible binder is more than or equal to 7.

25. The conductive ink according to claim 16, wherein the liquid carrier further comprises a second solvent selected from the group consisting of 2-phenoxy-ethanol, propylene-carbonate, n-butanol, gamma-butyro-lactone, dimethylsulphoxide, 2-butoxyethanol, dipropylene glycol methyl ether acetate, methyl isobutyl ketone, propylene glycol mono methyl ether acetate, methyl butyro-lactone, 5-dimethyl-amino-2-methyl-5-oxopentanoate, and combinations thereof.

26. A method of preparing a metallic layer or pattern comprising a first step of applying the conductive ink of claim 16 on a substrate followed by a second step of sintering.

27. The method according to claim 26, wherein the substrate is a paper substrate, a glass substrate, a polymeric substrate with or without a primer layer, or an ITO layer on a polymeric or glass support.

28. The method according to claim 26, wherein the conductive ink is applied on the substrate by intaglio printing, screen printing, flexographic printing, offset printing, inkjet printing, or gravure offset printing.

29. The method according to claim 26, wherein sintering is carried out at a temperature of 200° C. or less for 30 minutes or less.

30. The method according to claim 26, wherein sintering is carried out by exposing the metallic layer or pattern to near infrared radiation.
